(19) United States
(12) Patent Application Publication
(10) Pub. No.: US 2026/0192924 A1
(43) Pub. Date: Jul. 9, 2026

(54) CONTROL OF AN AIRCRAFT FURNITURE INSTALLATION

(71) Applicant: SAFRAN ELECTRONICS & DEFENSE ACTUATION, AUXERRE (FR)

(72) Inventors: Matthieu TREMOLLIERES, MOISSY-CRAMAYEL (FR); Kevin RAMASAMY, MOISSY-CRAMAYEL (FR); Geoffrey VIRLOT, MOISSY-CRAMAYEL (FR); Laurent NIVET, MOISSY-CRAMAYEL (FR)

(73) Assignee: SAFRAN ELECTRONICS & DEFENSE ACTUATION, AUXERRE (FR)

(21) Appl. No.: 19/133,047

(22) PCT Filed: Nov. 28, 2023
(86) PCT No.: PCT/FR2023/051859

§ 371 Date: May 27, 2025

(30) Foreign Application Priority Data
Nov. 28, 2022 (FR) 2212445

(51) Int. Cl. B64D 11/06; G05D 3/20; G06F 8/61

(52) U.S. Cl. CPC B64D 11/064; B64D 11/0601; B64D 11/0641; G05D 3/20; G06F 8/61

(57) ABSTRACT

An aircraft furniture installation has a seat and a movable object. A method for controlling the aircraft furniture installation include receiving a command to move the seat; receiving a position of at least one element of the seat and at least one position of the movable object; and determining a prohibited area for the seat, depending on the position of the movable object. The method further includes moving the seat according to the command received and comparing the position of each element of the seat with the prohibited area. If the comparison indicates that the seat reaches the prohibited area, the method further includes determining a movement of the movable object separating the prohibited area from the seat; and moving the movable object according to the determined movement.

### TECHNICAL FIELD OF THE INVENTION

The present invention relates to a method for controlling a furniture installation of an aircraft, an associated computer program, a system for controlling a furniture installation of an aircraft and an aircraft comprising such a control system.

### TECHNICAL BACKGROUND

In order to improve passenger comfort, many seats are equipped with electric actuating devices that allow the seat configuration to be changed by moving its movable parts.

For example, such a seat comprises a reclinable backrest and a footrest, each articulated at one end of a seat cushion. Each is moved by its own actuator. The seat itself can sometimes be moved globally in relation to a floor of the aircraft.

Hereafter, the expression “movement of the seat” will be understood to mean both a movement of one or more movable elements of the seat and a movement of the seat as a whole.

Such a seat is mechanically modelled by a set of particular points, for example the free end of the backrest or footrest, and each particular point is moved along a predefined trajectory associated with it and enabling each particular point to avoid obstacles in order to pass from a first to a second predetermined position.

When certain parts of the seat collide with obstacles, this can lead to damage to these obstacles and/or the seat.

To avoid this problem, the patent application published under number FR 2 821 252 A1 describes a method for controlling an aircraft furniture installation, the furniture installation comprising a seat and a movable object, comprising:
receiving a command to move the seat;
receiving a position of at least one element of the seat and at least one position of the movable object;
determining a prohibited area for the seat, as a function of the position of the movable object;
moving the seat according to the command received; and
comparing the position of each element of the seat with the prohibited area.

In this patent application, the seat is stopped when it reaches the prohibited area, so that it cannot reach the position desired by the user.

It may therefore be desirable to provide a method which avoids at least some of the aforementioned problems and constraints.

### SUMMARY OF THE INVENTION

A method is therefore proposed for controlling an aircraft furniture installation, the furniture installation comprising a seat and a movable object, comprising:
receiving a command to move the seat;
receiving a position of at least one element of the seat and at least one position of the movable object;
determining a prohibited area for the seat, as a function of the position of the movable object;
moving the seat in accordance with the command received; and
comparing the position of each element of the seat with the prohibited area; characterized by:
if the comparison indicates that the seat reaches the prohibited area, determining a movement of the movable object separating the prohibited area from the seat; and
moving the movable object according to the determined movement.

Thus, thanks to the invention, the risk of collision with the movable object is reduced and the seat can reach the position desired by the user.

The invention may further comprise one or more of the following optional characteristics, in any technically possible combination.

Optionally, the positions are determined in a Cartesian coordinate system.

Also optionally, the prohibited area is defined by one or more straight line segments.

Also optionally, the seat comprises several elements movable relative to one another, and movement of the seat comprises movement of at least one of the elements of the seat.

Also optionally, the movable object comprises several elements movable relative to one another, the position of the movable object is a position of at least one of the elements of the movable object and the movement of the movable object comprises a movement of at least one of the elements of the movable object.

Optionally, the movable object is another seat.

Also proposed is a computer program which can be downloaded from a communications network and/or recorded on a computer-readable medium, characterized in that it comprises instructions for executing the steps of a method according to the invention, when said program is executed on a computer.

Also proposed is a control system for an aircraft furniture installation, the furniture installation comprising a seat and a movable object, designed to implement a method according to the invention.

An aircraft is also proposed comprising:
a furniture installation with a seat and a movable object; and
a control system according to the invention.

### BRIEF DESCRIPTION OF THE FIGURES

The invention will be better understood with the aid of the following description, given solely by way of example and made with reference to the appended drawings in which:

FIG. 1 is a side view of an example of an aircraft furniture installation, according to the invention, comprising two seats,

FIG. 2 is a block diagram of a method for controlling the seats in the furniture installation shown in FIG. 1,

FIG. 3 shows a different initial seat configuration to that shown in FIG. 1,

FIG. 4 shows an intermediate configuration of the seats, and

FIG. 5 shows a final configuration of the seats.

### DETAILED DESCRIPTION OF THE INVENTION

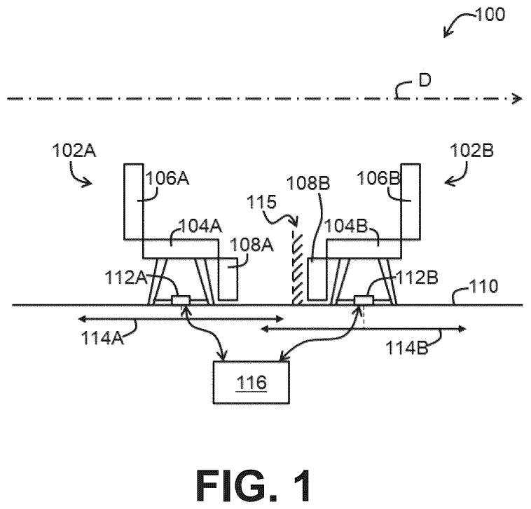

With reference to FIG. 1, an example of an aircraft furniture installation 100, according to the invention, will now be described.

The furniture installation 100 firstly comprises two seats 102A, 102B facing each other. Each seat 102A, 102B comprises several elements, such as a seat cushion 104A, 104B, a backrest 106A, 106B and a footrest 108A, 108B.

The seats 102A, 102B are designed to move in translation, relative to a floor 110 of the aircraft, in a direction D, in order to move towards or away from each other. Subsequently, the elements 104A, 106A, 108A, 104B, 106B, 108B of each seat 102A, 102B are considered to remain fixed with respect to each other, so that the only movement considered is translation along the direction D. It is therefore possible to consider that each seat 102A, 102B is formed from a single element.

To this end, each seat 102A, 102B comprises a respective actuator 112A, 112B designed to move the seat 102A, 102B along the direction D, over a respective predefined stroke 114A, 114B. As illustrated, the strokes 114A, 114B overlap so that the seats 102A, 102B can collide.

Each actuator 112A, 112B is further designed to transmit a position, along the direction D in the illustrated example, of the seat 102A, 102B which it moves. This position is determined, for example, in a Cartesian coordinate system fixed to the ground 110.

The position of seat 102B defines a prohibited area 115 for the seat 102A. This prohibited area 115 surrounds the seat 102B and corresponds to points in the space that the seat 102A must not occupy in order to avoid a collision with the seat 102B. The position of the prohibited area 115 changes with the movement of the seat 102B, for example it moves with the movement of the seat 102B. In the simple example shown in FIG. 1, the prohibited area 115 corresponds to a half-plane defined by a vertical line segment moving with the seat 102B.

The furniture installation 100 further comprises a control system 116 connected to the two actuators 112A, 112B to control them in order to move the seats 102A, 102B and to receive the positions of the seats 102A, 102B.

For example, the control system 116 is a computer system comprising a data processing unit (such as a microprocessor) and a main memory (such as a RAM-Random Access Memory) accessible by the processing unit. The computer system may also comprise a network interface and/or a computer-readable medium, such as a local medium (such as a local hard disk) or a remote medium (such as a remote hard disk accessible via the network interface through a communications network) or even a removable medium (such as a Universal Serial Bus (USB) flash drive, or a Compact Disc (CD) or Digital Versatile Disc (DVD)) readable by means of an appropriate reader in the computer system (such as a USB port or a CD and/or DVD drive). A computer program containing instructions for the processing unit is stored on the medium and/or can be downloaded via the network interface. This computer program is, for example, intended to be loaded into the main memory, so that the processing unit can execute its instructions, in order to implement the steps of the method which will be described later.

Alternatively, all or some of these steps could be implemented in the form of hardware modules, i.e. in the form of an electronic circuit, for example micro-wired, not involving a computer program.

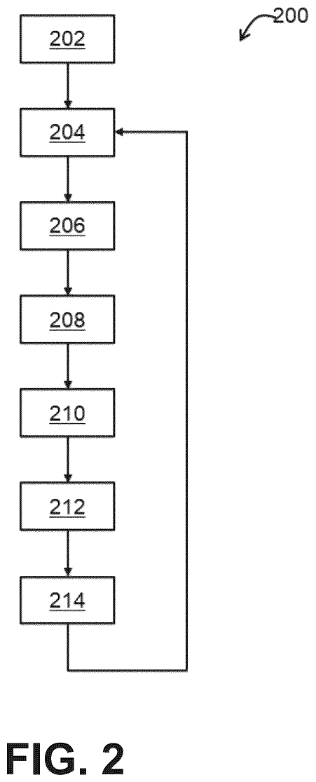

With reference to FIG. 2, an example of a method 200 for controlling the seats 102A, 102B will now be described.

During a step 202, the control system 116 receives a command to move the seat 102A, a translation in the direction of the seat 102B in the illustrated example.

During a step 204, the control system 116 receives the positions of the seats 102A, 102B.

During a step 206, the control system 116 determines the prohibited area 115 for the seat 102A, as a function of the position of the seat 102B.

During a step 208, the control system 116 moves the seat 102A according to the command received, i.e. in the direction of the seat 102B.

During a step 210, the control system 116 compares the position of the seat 102A with the prohibited area 115.

If the comparison indicates that the seat 102A reaches the prohibited area 115, the control system 116 determines, during a step 212, a movement of the seat 102B to move the prohibited area 115 away from the seat 102A. For example, the control system 116 comprises at least one predefined association associating a movement of the seat 102A with a movement of the seat 10B away from the prohibited area 115. The movement of the seat 102B to move the prohibited area 115 away from the seat 102A is therefore the movement associated with the current movement of the seat 102A, according to the predefined association(s). In the simple example shown in FIG. 1, the control system 116 comprises, for example, an association between a forward movement of the seat 102A and a rearward movement of the seat 102B. Thus, in the example described, the control system 116 selects rearward movement of the seat 102B.

In a step 214, the control system 116 moves the seat 102B according to the movement determined in the previous step.

The method 200 then returns to step 204 and continues to implement this loop of steps until the seat 102A reaches its final position.

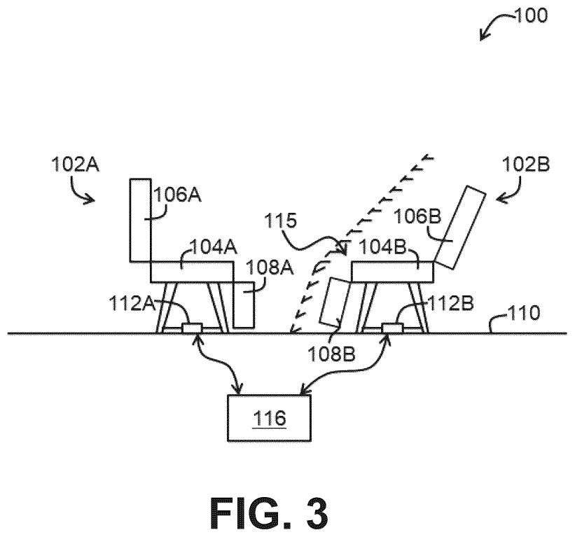

With reference to FIG. 3, the elements 104A, 106A, 108A, 104B, 106B, 108B of each seat 102A, 102B are this time movable relative to each other. In particular, the footrest and backrest are each designed to pivot relative to the seat cushion to move the seat from a seating configuration to a bed configuration.

Actuators (not shown) similar to actuators 112A, 112B are then provided to enable these movements and transmit the positions of the various elements. These positions are determined, for example, in a Cartesian coordinate system fixed to the ground 110.

The prohibited area 115 is this time defined by several straight line segments whose relative positions depend on the relative positions of the seat elements 102B.

The method shown in FIG. 2 can again be applied.

Thus, during a step 202, the control system 116 receives a command to move the seat 102A, for example from the seat configuration to the bed configuration.

During a step 204, the control system 116 receives the positions of the seat elements 102A, 102B. For example, the seat 102B is in an intermediate configuration between the seat position and the bed position.

During a step 206, the control system 116 determines the prohibited area 115 for the seat 102A, as a function of the positions of the elements of the seat 102B.

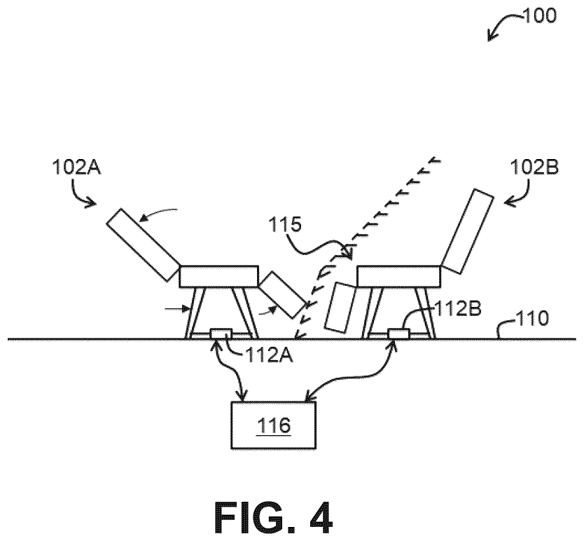

During a step 208, the control system 116 moves the seat 102A according to the command received, i.e. by reclining the backrest and the footrest, while moving the seat cushion forward (see FIG. 4).

In a step 210, the control system 116 compares the position of the seat elements 102A with the prohibited area 115. This comparison is made, for example, by comparing at least one critical point of each of at least one element (generally an end point of the element) with the prohibited area 115.

If the comparison indicates that the seat 102A reaches the prohibited area 115 (see FIG. 4 where the footrest 108A reaches the prohibited area 115), the control system 116 determines, during a step 212, a movement of at least one element of the seat 102B to move the prohibited area 115 away from the seat 102A. For example, the control system 116 comprises at least one predefined association associating a movement of at least one element of the seat 102A with a movement of at least one element of the seat 102B away from the prohibited area 115. The movement of the seat 102B to move the prohibited area 115 away from the seat 102A is therefore the movement associated with the current movement of the seat 102A, according to the predefined association(s). In the example described, the control system 116 comprises, for example, an association between a movement towards the bed configuration of the seat 102A and a movement towards the seat configuration of the seat 102B. Thus, in the example described, the control system 116 selects the movement of the seat 102B towards its seating position.

In a step 214, the control system 116 moves the seat 102B according to the movement determined in the previous step.

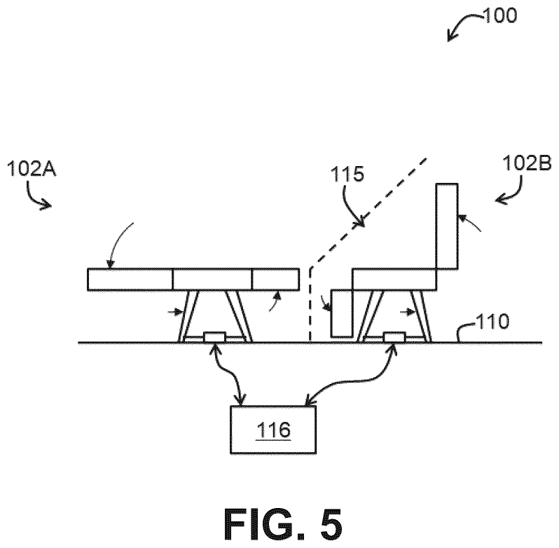

The method 200 then returns to step 204 and continues to implement this loop of steps until the seat 102A reaches its final position (see FIG. 5).

It should also be noted that the invention is not limited to the embodiments described above. In fact, it will appear to the person skilled in the art that various modifications can be made to the above-described embodiments, in the light of the teaching just disclosed.

In particular, the roles of seats 102A, 102B could be interchanged.

In addition, the seat 102B could be another movable object that can be moved by the control system 116, such as: a table, a mini-bar, a meal tray, a screen, etc.

In the detailed presentation of the invention given above, the terms used are not to be interpreted as limiting the invention to the embodiments set forth in the present description, but are to be interpreted as including all equivalents the anticipation of which is within the reach of the person skilled in the art by applying his general knowledge to the implementation of the teaching just disclosed.

1. A method for controlling an aircraft furniture installation, the furniture installation comprising a seat and a movable object, the method comprising:
receiving a command to move the seat;
receiving a position of at least one element of the seat and at least one position of the movable object;
determining a prohibited area for the seat as a function of the position of the movable object;
moving the seat in accordance with the command received; and
comparing the position of each of the at least one element of the seat with the prohibited area;
wherein, if the comparison indicates that the seat reaches the prohibited area, the method further includes determining a movement of the movable object separating the prohibited area from the seat; and
moving the movable object according to the determined movement.

2. The method according to claim 1, wherein the positions are determined in a Cartesian coordinate system.

3. The method according to claim 1, wherein the prohibited area is defined by one or more straight line segments.

4. The method according to claim 1, wherein the seat comprises several elements movable relative to one another, and wherein moving the seat comprises moving at least one of the elements of the seat.

5. The method according to claim 1, wherein the movable object comprises a plurality of elements that are movable relative to one another, wherein the position of the movable object is a position of at least one of the elements of the movable object and wherein movement of the movable object comprises a movement of at least one of the elements of the movable object.

6. The method according to claim 1, wherein the movable object is another seat.

7. A computer program downloaded from a communications network and/or recorded on a computer-readable medium,
the computer program comprising instructions for executing the steps of the method according to claim 1, when said program is executed on a computer.

8. A control system for a furniture installation of an aircraft, the furniture installation comprising a seat and a movable object, being designed to implement the method according to claim 1.

9. An aircraft comprising:
a furniture installation with a seat and a movable object; and
the control system according to claim 8.
